(19) United States
(12) Patent Application Publication
(10) Pub. No.: US 2007/0095407 A1
(43) Pub. Date: May 3, 2007

(54) Electrically controlled addressable multi-dimensional microfluidic device and method

(75) Inventors: Peilin Chen, Taipei (TW); Jau-Ye Shiu, Taoyuan County (TW); Chiung-Wen Kuo, Taipei City (TW)

Correspondence Address: FISH & RICHARDSON PC, P.O. BOX 1022, MINNEAPOLIS, MN, 55440-1022, US

(73) Assignee: ACADEMIA SINICA

(21) Appl. No.: 11/262,495

(22) Filed: Oct. 28, 2005

(51) Int. Cl. F16K 11/20

(52) U.S. Cl. 137/597

(57) ABSTRACT

A microfluidic device that includes one or more microchannels configured to transport fluid, and one or more microchambers configured to receive the fluid, wherein each of the one or more microchannels is coupled in fluid communication to at least one of the one or more microchambers. The microfluidic device also includes a first set of electrodes, each of the electrodes electrically coupled to one of the one or more microchannels, and configured to selectively apply an adjustable voltage to the respective microchannel to cause the fluid in that microchannel to flow. The microfluidic device further includes a second set of electrodes, where each of the electrodes in the second set of electrodes is electrically coupled to corresponding microchambers and configured to apply an adjustable voltage to the corresponding microchambers to direct flowing fluid into those corresponding microchambers from the microchannels to which those corresponding microchambers are coupled.

### TECHNICAL FIELD

This invention relates to microfluidic devices, and more particularly to addressable multi-dimensional microfluidic devices.

### BACKGROUND

Microfluidic systems are miniaturized devices that are used to manipulate and control the flow of fluids, and thus provide a powerful platform for processing and studying biological assays and/or chemical solutions. Advantages of using microfluidic systems include minimal use of reagents, short reaction time, low cost, and capability of integration with other miniaturized functional components. Over the past few years there have been technological advances in the development of using microfluidic devices for patterning and growing materials.

In many microfluidic devices fluidic samples are manipulated inside one-dimensional microchannels by employing various pumping mechanisms. However, the one-dimensional microchannels cannot easily be scaled-up to the degree of complexity and integration needed to replicate elaborate laboratory assays. To conduct complicated laboratory tasks in the miniaturized devices, multi-dimensional microfluidic systems are required. Such multi-dimensional microfluidic systems require large-scale integration of microfluidic miniaturized control components, such as pumps to cause fluids to flows, and valves that direct the flowing fluids into their destinations in the microfluidic channels. Large scale integration of such miniaturized devices and components presents many implementation challenges as miniaturization of devices and components for microfluidic devices are difficult and costly to fabricate.

### SUMMARY

In one aspect, the invention includes a microfluidic device. The microfluidic device includes one or more microchannels configured to transport fluid, and one or more microchambers configured to receive the fluid, wherein each of the one or more microchannels is coupled in fluid communication to at least one of the one or more microchambers. The microfluidic device also includes a first set of electrodes, each of the electrodes electrically coupled to one of the one or more microchannels, and configured to selectively apply an adjustable voltage to the respective microchannel to cause the fluid in that microchannel to flow. The microfluidic device further includes a second set of electrodes, where each of the electrodes in the second set of electrodes is electrically coupled to corresponding microchambers and configured to apply an adjustable voltage to the corresponding microchambers to direct flowing fluid into those corresponding microchambers from the microchannels to which those corresponding microchambers are coupled.

In some embodiments the one or more microchannels and the one or more microchambers are arranged in a two-dimensional configuration.

In some embodiments the one or more microchannels and the one or more microchambers are disposed on a first substrate. In some embodiments the first substrate is manufactured from polydimethylsiloxane.

In some embodiments the first set of electrodes and the second set of electrode are disposes on a second substrate. In some embodiments the second substrate is manufactured from ITO glass.

In some embodiments the microfluidic device further includes at least one fluid reservoir having an inlet opening, the at least one fluid reservoir configured to receive the fluid. The microfluidic device also includes a delivery channel having a hollow interior, the delivery channel coupled in fluid communication to an opening of the at least one fluid reservoir and to the openings of the one or more microchannels, the delivery channel configured to deliver the fluid from the at least one fluid reservoir to at least some of the one or more microchannels.

In some embodiments the microfluidic device further includes a third set of electrodes electrically coupled to the at least one fluid reservoir and to the delivery channel, the third set of electrodes configured to apply an adjustable voltage to the at least one fluid reservoir and to the delivery channel to cause fluid to flow in the delivery channel.

In some embodiments each of the one or more microchambers includes an inlet to receive the fluid from the respective microchannel to which that microchamber is coupled.

In some embodiments each of the one or more microchambers is coupled in fluid communication to a corresponding drainage channel configured to deliver processed materials from that microchamber to one or more drainage fluid reservoirs.

In some embodiments each of the one or more microchambers includes an outlet coupled in fluid communication to the corresponding drainage channel.

In some embodiments the one or more microchannels is coated with organic film. In some embodiments the fluid includes, for example, biological samples, and/or chemical samples.

In some embodiments the microfluidic device further includes a flushing mechanism configured to flush out the fluid from, for example, the one or more microchannels, and/or the one or more microchambers. In some embodiments the flushing mechanism includes a pump configured to pump into the microfluidic device, for example, a flushing solution, and/or a high pressure gas.

In another aspect, the invention includes a method for delivering fluid to a microchamber in a microfluidic device. The method includes providing fluid to the opening of a microchannel coupled in fluid communication to the microchamber, applying a first electrical voltage to the microchannel to cause the fluid to flow in the microchannel, and applying a second electric voltage to the microchamber to direct the flowing fluid in the microchannel into the microchamber.

In another aspect, the invention includes a method for delivering fluid to a particular microchamber disposed in a multi-dimensional microfluidic device, the device comprising one or more microchambers, where each of the one or more microchambers is coupled in fluid communication to one of one or more microchannels. The method includes providing fluid to a reservoir coupled in fluid communication to the one or more microchannels, applying a first voltage to a microchannel coupled to the particular microchamber, the microchannel selected from the one or more microchannels, and applying a second voltage to the fluid flowing in the selected microchannel to direct the flowing fluid into the particular microchamber.

In another aspect, the invention includes a photonic display device. The photonic display device includes a fluid reservoir configured to receive at least one type of polystyrene nanoparticles characterized by an associated colloidal diameter, and one or more microchannels configured to transport the at least one type of polystyrene nanoparticles. The photonic display device also includes one or more microchambers configured to receive the at least one type of polystyrene nanoparticles and to form a colloidal crystal therefrom, wherein each of the one or more microchannels is coupled in fluid communication to at least one of the one or more microchambers. The photonic display device further includes a first set of electrodes, each of the electrodes electrically coupled to one of the one or more microchannels, and configured to selectively apply an adjustable voltage to the respective microchannel to cause the at least one type of polystyrene nanoparticles in that microchannel to flow. The photonic display device also includes a second set of electrodes, where each of the electrodes in the second set of electrodes is electrically coupled to corresponding microchambers and configured to selectively apply an adjustable voltage to the corresponding microchambers to direct into those corresponding microchambers the at least one type of polystyrene nanoparticles flowing in the microchannels to which those corresponding microchambers are coupled. The photonic display device further includes a light source configured to illuminate the one or more microchambers.

In another aspect, the invention includes a method for displaying images on a multi-dimensional microfluidic device, the device comprising one or more microchambers, where each of the one or more microchambers is coupled in fluid communication to one of one or more microchannels. The method includes providing at least one type of polystyrene nanoparticles to a reservoir coupled in fluid communication to the one or more microchannels, and applying a first voltage to a microchannel coupled to a particular microchamber, the microchannel selected from the one or more microchannels, to cause the at least one type of polystyrene nanoparticles to flow into the selected microchannel. The method also includes applying a second voltage to selectively direct into the particular microchamber the at least one type of polystyrene nanoparticles flowing in the selected microchannel. The method further includes illuminating light on the one or more microchambers.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic of the layout of an exemplary embodiment of an addressable two-dimensional microfluidic network.

FIG. 2 is a schematic of the layout of an exemplary embodiment of an electrical connection network used to electrically control the movement of fluid in the microfluidic network of FIG. 1.

FIG. 3A is an electrically controlled addressable 12×28 microfluidic device.

FIG. 3B is photograph of a portion of the addressable two-dimensional microfluidic device of FIG. 3A to which a PBS solution containing red dye was controllably delivered to form the letter “C”.

FIG. 3C is a photograph of a portion of the addressable two-dimensional microfluidic device of FIG. 3A to which a BSA solution containing blue dye was controllably delivered to form the letter “A”.

FIG. 3D is a photograph of a portion of the addressable two-dimensional microfluidic device of FIG. 3A to which four different compositions of an LB Broth solution were controllably delivered to form the letter “S”.

Like reference symbols in the various drawings indicate like elements.

### DETAILED DESCRIPTION

Disclosed herein are devices and methods for controlling the movement of fluid in an addressable multi-dimensional microfluidic network comprising microchannels, and microchambers that are coupled in fluid communication to the microchannels. Controlling the movement of the fluid in the microfluidic network is performed using sets of electrodes that create electrocapillary pressure within the microchannels and/or microchambers, and thereby cause fluid to flow within selected microchannels, and be directed into selected microchambers.

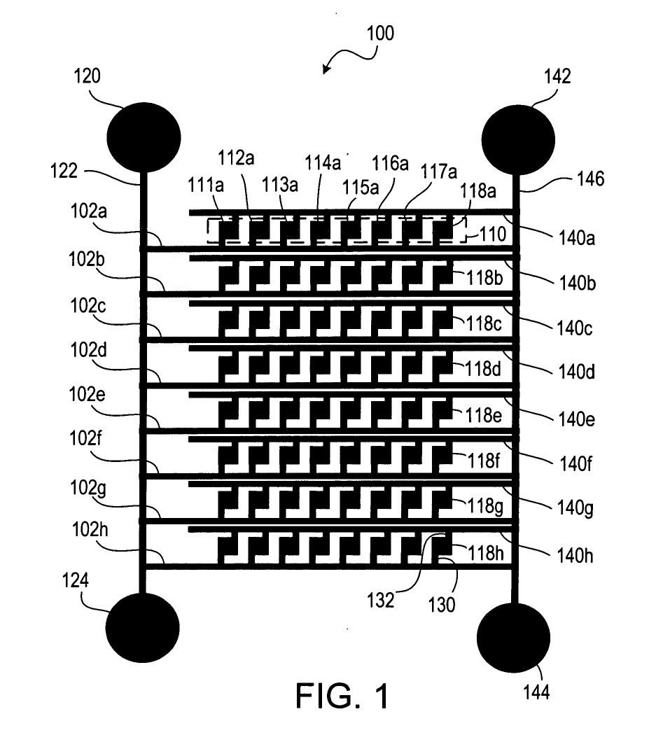

FIG. 1 is a schematic of the layout of an exemplary embodiment of an addressable two-dimensional microfluidic network 100. As can be seen, the microfluidic network 100 includes one or more microchannels 102a-h which are configured to transport fluids, including biological and chemical samples. The microchannels 102a-h have a substantially rectangular interior. In some embodiments the microchannels 102a-h have typical width and height dimensions of 50 μm, and 8 μm, respectively. However, other structures and dimensions for the microchannels may be used. For example, in some embodiments the microchannels may have a substantially cylindrical structure.

Each of the one or more microchannels 102a-h of the microfluidic network 100 is coupled in fluid communication to microchambers arranged in arrays. For example, microchamber array 110 includes microchambers 111a-118a. Each of the microchambers in the various arrays is configured to receive and retain fluids provided to the microfluidic network 100.

Although FIG. 1 illustrates a microfluidic network having eight microchannels, each of which is coupled to eight microchambers, the microfluidic network 100 can include fewer or additional microchannels. Further, each microchannel may be coupled to a different number of microchambers.

As can be seen with reference to exemplary microchamber 118h, in some embodiments the microchambers are box-shaped receptacles for receiving the fluids delivered via the respective microchannels to which the microchambers are coupled. The microchambers may have other shapes and structures. Exemplary width, length and height dimensions of the box-shaped microchamber 118h are respectively 200 μm×200 μm×30 μm, respectively. Each microchamber is coupled in fluid communication to an opening in the corresponding microchannel through an inlet. For example, microchamber 118h is coupled to one of the opening in microchannel 102h through an inlet 130. As further shown in FIG. 1, each microchamber also includes an outlet that is coupled in fluid communication to a corresponding drainage channel. Thus, for example, microchamber 118h is coupled in fluid communication to drainage channel 140h through an outlet 132. The drainage channels 140a-h of microfluidic network 100 are each configured to receive processed fluids, or other materials (e.g., crystals), from the microchambers coupled to the respective drainage channels, and to enable such processed fluids/materials to be flushed out of the microfluidic network 100 via exit channel 146 to one of the drainage reservoirs 142 and 144. Flushing of the microfluidic network 100 enables re-use of the microfluidic network 100 to perform a different procedure involving a new set of fluids. The flushed materials received at the drainage reservoirs 142 and 144 may be removed from the microfluidic network 100 using suitable removal mechanisms.

The use of an inlet and an outlet to couple a microchamber to a microchannel and a drainage channel, respectively, also enables fluid received in the microchamber to be retained there. Specifically, the narrow interiors of the inlet and outlet openings of the microchamber create sufficient capillary force to prevent fluid from flowing or leaking outside the microchamber, and thus keep the fluid in the microchamber.

Movement of fluid in the microfluidic network 100 is controlled electrically, thereby enabling the use of a convenient and efficient control mechanism that does not require moving parts or the use of other substances (e.g., gases) to direct fluid to selected addressable target microchambers. The electrical control of the movement of fluid in the microfluidic network 100 is based on the application of the electrocapillary effect.

The use of the electrocapillary effect is predicated on the principle that the application of a voltage between an electrode positioned at, or proximate to, an interface (e.g., the bottom wall of a microchannel), and the fluid that is in contact with the interface modifies the electrical charge density that accumulates at the interface, and thereby changes the interfacial tension between the interface and the fluid. For example, a droplet of fluid that comes in contact with a neutral interface (i.e., an interface to which no voltage is applied) may not experience any interfacial tension and thus the dimensions and behavior of the droplet of fluid will remain unaltered. In contrast, the same droplet of fluid coming in contact with a charged interface (i.e., an interface to which a voltage is applied) experiences increased interfacial tension that consequently causes the droplet to expand and/or disperse. Thus, the changes to the interfacial tensions at the interface are sufficient to generate electrocapillary pressure to causes the fluid contacting the interface to expand and disperse, and thereby cause the fluid to move along the contours of the interface. The electrocapillary effect can thus be used to actively move micro and nanoparticles in microfluidic networks by modifying the electrical voltages applied to the walls of the microchannels.

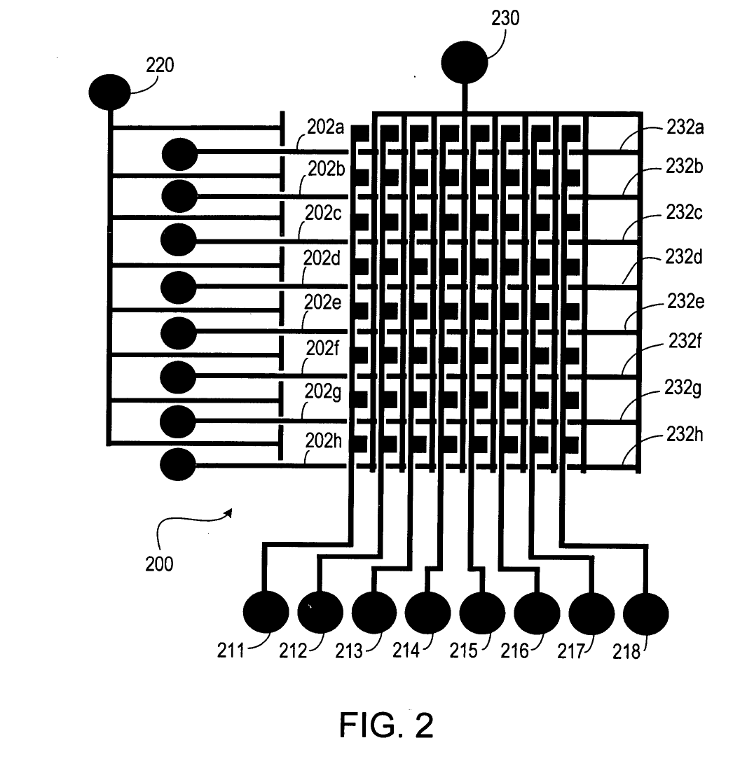

FIG. 2 is a schematic of the layout of a network 200 of electrical connections used in conjunction with the microfluidic network of FIG. 1 to electrically control the movement of fluid in the microfluidic network 100. The electrical connection network 200, together with, among other parts, the microfluidic network 100, comprise an electrically controlled addressable multidimensional microfluidic device.

As shown in FIG. 2, the electrical connection network 200 includes electrodes constructed as conducting strips having a spatial configuration that substantially matches the spatial configuration of the microfluidic network 100. Specifically, the electrical connection network 200 includes row electrodes 202a-h which correspond to the microchannels 102a-h. The spatial configuration of the row electrodes 202a-h substantially matches the spatial configuration of the microchannels 102a-h. The row electrodes control the movement of fluid in the microchannels 102a-h. Those row electrodes push fluid into selected microchannels and cause that fluid to begin flowing in the selected microchannels. As such, each of the row electrodes performs a function that is analogous to the function performed by a pump. The voltage applied to the row electrodes affects the velocity at which fluid flows in the microchannels. For example, a 150V (AC or DC) voltage source applied to the row electrodes can cause fluid samples to move in the corresponding microchannels at a rate of 75 μm/second.

The electrical connection network 200 also includes a set of column electrodes 211-218 whose spatial configuration substantially matches the spatial configuration of the microchambers of the microfluidic network 100. Thus, for example, the stripe-shaped column electrode 218 extends along a spatial path that substantially matches the spatial locations of microchambers 118a-h in the microfluidic network 100. The column electrodes 211-218 direct fluid from selected microchannels into selected microchambers. As such, each of the column electrodes 211-218 performs a function that is analogous to the function performed by a valve.

To illustrate the operation of the row and column electrodes, suppose that fluid is to be directed into microchamber 117a (which is coupled to microchannel 102a). Under these circumstances the electrode 202a, corresponding to microchannel 102a, would have to be activated to cause fluid to flow in microchannel 102a. Subsequently, column electrode 217 would have to be activated to cause fluid flowing in the microchannel 102a to be directed into the microchamber 117a.

To prevent electrical contact between the row electrodes 202a-h and the column electrodes 211-218 so that the electrical connection network 200 does not short-circuit, the row electrodes are separated from the column electrode and thus may only extend a short distance along the end-sections of the microchannels through which fluid enters the microchannels (i.e., the row electrodes do not reach any of the microchambers arranged along the microchannels). In some embodiments the row electrodes are separated from column electrodes by 50 μm gaps. Thus, although the configuration of the row electrodes 202a-h enables the selection of the microchannels through which fluid is to be transported, the electrodes 202a-h do not extend far enough along the path of the microchannels to provide the electrocapillary pressure needed to maintain the flow of fluids in the selected microchannels. Therefore, to enable movement of the fluid along the entire length of the selected microchannels, electrical connection network 200 also includes the electrode 230 and the line-shaped electrical contacts 232a-h commonly connected to the electrode 230. The electrical contacts 232a-h thus have the same voltage level as that applied to electrode 230. In some embodiments the voltage applied at electrode 230 is 150V. The electrode 230, and the electrical contacts 232a-h connected thereto, provide the electrical power required to transport fluid through the microchannels that were previously selected using electrodes 202a-h. The voltage level at the electrical contacts 232a-h is applied to the walls of the respective microchannels 102a-h, thereby altering the interfacial tension at the walls of the microchannels. The modified interfacial tension at the walls of the microchannels 102a-h causes fluid already present in at least some of those microchannels to continue flowing along the microchannels. As noted, the fluid is introduced into such microchannels through the selective activation of the row electrodes 202a-h.

Turning back to FIG. 1, the sample fluid that is delivered to the microchambers is first received in input fluid reservoirs 120. Additional input fluid reservoirs may be added to the microfluidic network 100. The sample fluid is delivered from an external source (not shown) to the fluid reservoir 120 using, for example, micropipettes, or other types of fluid conduits and/or delivery mechanisms. The micropipette is removably connected to an inlet or opening (not shown) in the fluid reservoir 120. Subsequently, the fluid received in the fluid reservoir 120 is delivered to the microchannels 102a-h via a delivery channel 122 having a hollow interior configured to transport fluids. In some embodiments the delivery channel 122 is a hollow rectangular tube having a plurality of openings on its wall that enable the microchannels 102a-h to be connected in fluid communication to the hollow interior of the delivery channel 122, and thus receive the fluid delivered from the input reservoir 120. Other structures for the delivery channel 122 may be used.

The electrocapillary effect is also used to cause fluid to flow from input reservoir 120 through the delivery channel 122. As shown in FIG. 2, the electrical connection network 200 further includes a delivery electrode 220. The delivery electrode 220 has a configuration that substantially matches the spatial locations of the delivery channel 122 in the microfluidic network 100, and of the end-sections of the microchannels 102a-h coupled to the delivery channel 122. Thus, to cause fluid to flow from input fluid reservoir 120 to the openings of the microchannels 102a-h, a voltage is applied to the electrode 220. The application of the voltage causes the voltage level at the walls of the delivery channel 122 and the walls at the end-sections of the microchannels 102a-h to change, thereby altering the interfacial tension at those walls. As a result of the change to the interfacial tension, fluid begins to flow through the delivery channel 122 and through the openings at the entrances to the microchannels 102a-h. In some embodiments, the voltage source connected to the delivery electrode 220 has a voltage level of 150V.

As further shown in FIG. 1, connected to the other end of delivery channel 122 is drainage reservoir 124. The drainage reservoir is configured to receive excess fluids not delivered to the microchambers in the microfluidic network 100. Subsequently, the excess fluids received at the drainage reservoir 124 may be removed from the microfluidic network 100 using suitable removal mechanisms. Occasionally, as will be described in more detail below, it becomes necessary to flush out all fluids present in the various channels (e.g., microchannels, drainage channels, etc.). Fluids flushed out from the microchannels 102a-h and the delivery channel 122 are drained into drainage reservoir 124, whereupon those flushed out fluids are removed at some later point.

In some embodiments, the microfluidic network 100 is fabricated using a replica-molding process using polydimethylsiloxane (PDMS) to produce a substrate having the desired microfluidic network configuration. In such a process, a master silicon wafer is first produced by coating a silicon wafer with a photoresist material having the desired microfluidic network pattern, and exposing the coated wafer to ultraviolet light through the photoresist mask. Subsequently, after the master has been produced, PDMS molding is performed by pouring the PDMS material onto the silicon master having the desired pattern, and curing the PDMS applied to the master mold to replicate the desired features. Other processes for fabricating microfluidic networks, including soft-lithography techniques that use other replicating materials (e.g., thermoset polyester), injection molding techniques, laser ablation techniques, etc., may also be used. An example of a typical microfluidic network device manufactured using a PDMS-based replica molding technique is a 4×4 cm² device having parallel microchannels that are 50 μm wide and 8 μm high.

In some embodiments, the electrical connection network 200 is fabricated by coating a thin layer of photoresist on top of an ITO glass substrate. Conventional photolithography techniques may then be used to create the electrode pattern corresponding to the electrical connection network 200. After development, the unprotected part of the conductive layer on the ITO glass is removed, using, for example, a 1:3 mixture of nitric acid and hydrochloric acid. The photoresist material that was used to form the electrode pattern is then removed by using a suitable solvent. The resultant processed ITO glass substrate thus has the desired electrical connection configuration on it. Other techniques and materials for fabricating the electrical connection network 200 may be used.

The microfluidic device is thus constructed by attaching the conductive layer, comprising the electrodes laid out in the desired configuration, to the PDMS layer constituting the desired microfluidic network. In some embodiments the PDMS layer, having the microfluidic network, is separated from the ITO glass layer, having the electrical connection network, using an additional insulation layer. In some embodiments the insulation layer may also be constructed from PDMS, although other suitable materials may be used.

Although not shown, the microfluidic network device, comprising the microfluidic network 100 in combination with the electrical connection network 200 also includes a control module that controls the voltages applied to the electrical connection network 200. The control module enables automatic or manual setting of the electrodes comprising the electrical connection network 200 to control the flow of the target fluid in the microfluidic network 100 to direct the fluid to the correct target microchambers in the microfluidic network 100. In some embodiments the control module is a processor-based device that includes a user interface to enable a user to specify the microchambers into which fluid in the input fluid reservoir 200 is to be directed. Once the user specifies the microchambers, and/or other operational parameters (e.g., what fluids are to be delivered to the microchambers, for how long should the microchambers retain the received fluids, etc.), the control module automatically determines which electrodes have to be set, and at what time and order the fluids are to be delivered to the microchambers specified by the user. Thus, the control module may include a computer and/or other types of processor-based devices suitable for multiple applications. Such devices can include volatile and non-volatile memory elements, and peripheral devices to enable input/output functionality. Such peripheral devices include, for example, a CD-ROM drive and/or floppy drive, or a network connection, for downloading software containing computer instructions to enable general operation of the processor-based device, and for downloading software implementation programs to control the operation of the electrodes of the electrical connection network 200 that controls the movement of fluids in the microfluidic network 100.

In operation, a sample fluid is introduced into the input fluid reservoir 120 using conventional delivery mechanism such as pumps, micropipettes, etc. Alternatively, the fluid reservoir 120 may be connected to another processing apparatus that processed the sample solution before it is received in the fluid reservoir 120.

The control module that controls the setting of the electrodes in the electrical connection network 200 determines which microchambers in the microfluidic network 100 are to receive the fluid in fluid reservoir 120. Such a determination may be based on input data provided by a user specifying the particular microchambers that are to receive the fluid, or it may be based on some pre-determine microchamber location specification. The control module can thus determine which electrodes have to be activated, and at what voltage, time, and order such electrodes are to be activated.

To deliver fluid to the specified microchambers, electrode 220 is first activated.

Once activated, the voltage of the electrode 220 is applied to the walls of delivery channel 122. The voltage may be applied through an insulation layer separating the electrical connection network 200 and the microfluidic network 100. Consequently, the interfacial tension along the walls of delivery channel 122 is altered, and as a result electrocapillary pressure within the delivery channel 122 is formed. This electrocapillary pressure causes fluid to flow from the fluid reservoir 120 through the delivery channel 122 and to the entrance of the microchannels 102a-h. Thus, after the electrode 220 is activated, the sample fluid is presented at the entrance of all the microchannels of the microfluidic network 100.

After the fluid has been presented at the entrance of the microchannels 102a-h, the microchannels to which fluid is to be delivered are selected. Selection of the particular microchannels is achieved by activating the row electrodes corresponding to those particular microchannels.

For example, suppose that the sample fluid is to be delivered only to microchambers 112a (coupled to microchannel 102a) and microchamber 118f (coupled to microchannel 102f). Accordingly, to deliver fluid to those microchambers, the microchannels 102a and 102f are selected by applying voltage to electrodes 202a and 202f (as shown in FIG. 2). Application of a voltage (e.g., 150V) to those electrodes causes the interfacial tension along the walls of the front end-sections of the microchannels 102a and 102f to be altered. As a result of the change of the interfacial tension of the walls along the end-sections of the microchannels 102a and 102f, electrocapillary pressure is formed at those parts of the microchannels' walls, and causes the fluid present at the entrance to the microchannels 102a and 102f to start flowing in the microchannels. It should be noted that the voltage at electrode 220 continues to be applied so that fluid in the delivery channel 122, and thus at the entrance to the microchannels, continues to be available at the entrance to the microchannels.

Because the paths of the electrodes 202a-h terminate before any fluid flowing in the respective microchannels 102a-h reaches the first microchambers located on those microchannels, once fluid starts flowing in the selected microchannels the electrode 230 is activated, thus causing voltage to be applied along the length of the electrical contacts 232a-h that are commonly connected to the electrode 230. As a result, voltage is applied along the walls of the various microchannels whose path substantially matches the path of the electrical contacts 232a-h. Consequently, the interfacial tension along the sections of the walls of the microchannels 102a-f whose paths corresponds to the paths of the electrical contacts 232a-h will be altered. The altered interfacial tension creates electrocapillary pressure along those sections of the walls of microchannels 102a-h, thereby causing the fluids in the selected microchannels to continue flowing towards the destination microchambers.

Thus, in the above example, the application of voltage to electrode 230 causes the fluid flowing in microchannels 102a and 102f to continue flowing past the point where the corresponding path of the electrodes 202a and 202f terminated.

To direct the fluid now flowing in selected microchannels into the destination microchambers, the column electrodes corresponding to the destination microchambers have to be activated. Thus, voltage (e.g., 150V) is applied to those column electrodes corresponding to the destination microchambers, thereby causing a change to the interfacial tension along the walls of the destination microchambers, as well as to the walls of the inlets of the destination microchambers and to the sections of the walls of the microchannels that are proximate to the selected microchambers. The change to the interfacial tension at the walls of the selected microchambers, and to the areas near them, causes fluids in the selected microchannels to begin flowing towards and into the selected microchambers. The activation of voltage to the selected column electrodes is performed while the other electrodes (namely, the delivery electrode 220, the selected row electrodes, and the electrode 230) remain activated. Thus, in the above example, after fluid in the selected microchannels 102a and 102f has had sufficient time to flow in those microchannels and be available at the various microchambers lined along the microchannels, column electrode 212 and 218 (as shown in FIG. 2) are activated, thereby causing the fluid flowing in microchannels 102a and 102f to be directed to, and enter into microchambers 112a and 118f.

Once the sample fluid is received in the selected microchambers, the fluid remains in the selected microchamber due to the capillary force created by the two separate openings of each of the microchambers (e.g., the inlet opening and the outlet opening).

After the fluid has been delivered to its destination microchambers, the fluid remaining in the selected microchannels and in the delivery channel 122 may be withdrawn so as to enable the introduction of a different fluid for delivery to the same or different microchambers. The delivery of a different material to the same destination microchambers may be performed to achieve a desired chemical reaction in those microchambers. Such desired chemical reactions may be used to produce an intermediary target product (if additional materials are to be subsequently introduced into those microchambers), or a final target product.

to introduce a new material (e.g., fluid) into the microfluidic network 100, the voltage applied to various activated electrodes is terminated. In some embodiments voltage is terminated by first terminating the voltage to the selected column electrode, then terminating the voltage applied to electrode 230, followed by terminating the voltage to the selected row electrodes and to the delivery electrode 220. Once the voltages applied to the electrodes of the electrical connection network 200 are terminated, fluid flowing in the microchannels will begin to withdraw and to drain into the delivery channel 122. The fluid in delivery channel 122 drains into drainage reservoir 124. Fluid in the drainage reservoir 124 is then removed using conventional removal mechanisms (e.g., pumps). Similarly, excess sample fluid still contained in the fluid reservoir 120 is likewise removed using conventional removal mechanisms.

To introduce a different fluid, the new sample fluid is received in fluid reservoir 120. Subsequently, the control module connected to the electrical connection network 200 is used to control the activation of electrodes, in the manner described above, to deliver the new sample fluid to selected microchambers. Thus, if the new sample fluid is to be delivered to microchamber 118b and to the microchamber 118h (into which the first sample fluid has already been delivered), the control module would activate, in order, electrode 220, row electrodes 202b and 202h (to deliver the fluid to microchannel 102b and 102h, respectively), electrode 230, and column electrode 218 (to direct fluid from microchannels 102b and 102h into microchambers 118b and 118h, respectively). Subsequently, the above procedure may be repeated for additional fluids.

One cause for performance degradation of the microfluidic device is the accumulation of protein residue on the walls of the microchannels. The adsorption of protein on the walls of the microchannels can change the walls' surface energy, which in turn can modify the resultant electrocapillary pressure created through the application of voltage to the microchannels' walls. The effect of protein adsorption could be reduced by coating channel surfaces with a layer of organic films.

Occasionally it may become necessary to flush out all fluids, including fluids and/or materials contained in any of the microchambers, to prepare the microfluidic network 100 for a new use. In some embodiments PDMS based microfluidic devices could be cleaned and reused at least fifty times without any observable degradation in performance.

To flush the microfluidic network 100, the fluid in the microchannels 102a-h and in the delivery channel 122 is first drained by terminating the electrical voltages to the electrodes of the electrical connection network 200, and thereby causing fluids in the microchannels and delivery channel to drain to drainage reservoir 124. Subsequently, the fluid in drainage 124 and fluid reservoir 120 may be removed. Next, the content of the microchambers, as well as residual fluids in the microchannels 102a-h and in the delivery channel 122, are flushed by flushing the microfluidic network 100 with a flushing solution such as a 10⁻⁴ M KNO₃ solution, or by pumping high pressure gas, such as pressurized air or nitrogen, into the microfluidic network 100. Use of high pressure gas, for example, pumped through the microfluidic network 100 causes fluids and materials in the microchannels 102a-h, delivery channel 122, and in the microchambers coupled to the microchannels to be flushed out through drainage channels 140a-h and exit channel 146, into the drainage reservoirs 142 and 144. Fluids and materials received in drainage reservoirs 142 and 144 are subsequently removed using conventional removal mechanisms.

Although FIGS. 1 and 2 illustrate the implementation of an addressable two-dimensional microfluidic device comprising a two-dimensional microfluidic network and its complementary two-dimensional electrical connection network, additional addressable dimensions may be added to the microfluidic device. For example, a three-dimensional microfluidic device may be implemented. In such a device vertical microchannels extend from horizontal microchannels (which may be similar to the microchannels 102a-h), and arrays of microchambers are coupled in fluid communication to the horizontal microchannels and/or to the vertical microchannels. Controlling this type of an addressable three-dimensional microfluidic network configuration is a three-dimensional electrical connection network that includes, for example, a set of electrodes that controls and induces the flow of fluids in the horizontal microchannels, a set of electrodes that controls the flow of fluid in the vertical microchannels, and a set of electrodes to direct fluids into designated microchambers.

### Experimentation

To demonstrate the operation of the electrically controlled addressable microfluidic device comprising a microfluidic network, similar to microfluidic network 100, and an electrical connection network, similar to the electrical connection network 200, several experiments were conducted.

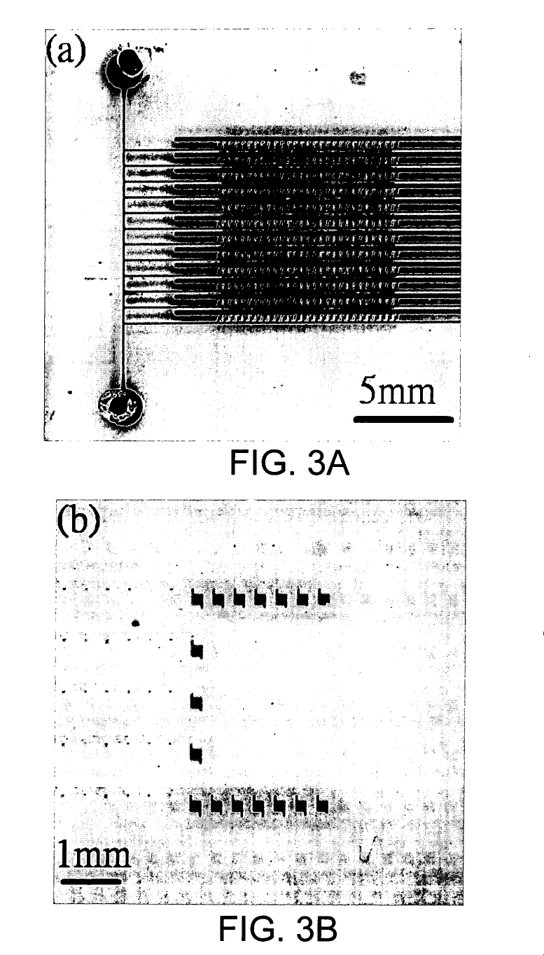

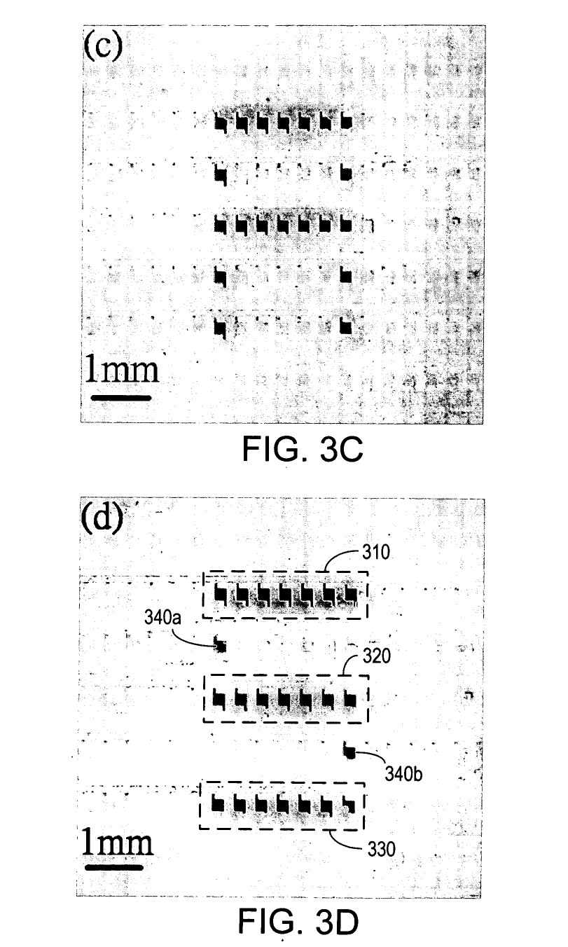

FIG. 3A shows a 12×28 microfluidic device (i.e., 12 microchannels, each of which is coupled in fluid communication to 28 microchambers) that was used in the experiments conducted. The row and column electrodes of the microfluidic device of FIG. 3A were fabricated on the same ITO glass. The microfluidic device of FIG. 3A was capable of moving fluidic samples at a velocity of up to several millimeters per second, depending on the applied voltage. In the experiments conducted a 150V AC voltage source was used, which caused the samples in the microfluidic device of FIG. 3A to be transported at a rate of 75 μm/s.

Three different solutions, all mixed with dyes for visualization, were introduced into the microfluidic device of FIG. 3A. The various solutions used were not otherwise processed or treated. In a typical experiment, 1 μl of samples were first loaded into the input reservoir by a micropipette and then delivered to the input microchannel via delivery channel 122. The samples were directed to the selected microchannels by applying voltage to the input delivery electrode (such as electrode 220) and the corresponding row electrodes. To introduce the sample to a specific microchamber, the voltage was applied to the selected column electrode (such as one or more of column electrodes 211-218). After the microchambers were loaded with samples, the applied voltage was removed. As the result of changes in the interfacial tension, the solution in the microchannel started to withdraw leaving samples in the selected microchambers. Before the injection of a second solution, the residual solution in the microchannels could be removed, if necessary, by flushing the microfluidic device with a 10⁻⁴ M KNO₃ solution, or by pumping pressurized gas into the microfluidic device.

The first solution used was phosphate buffered saline solution (PBS), which is a common buffer solution. The PBS solution was mixed with the Acid Fuchsin red dye to enable visual tracking of the location of the PBS solution within the microfluidic network. FIG. 3B is photograph of a portion of an addressable two-dimensional microfluidic device to which the PBS solution containing the red dye was controllably delivered. As shown, the movement of the PBS solution was controlled to enable the formation of the letter “C” in the microfluidic device.

Next, after the PBS solution was used to pattern the letter “C”, the microfluidic device was flushed, and another PBS solution containing bovine serum albumin (BSA) was used to construct the letter “A” in the microfluidic device. The BSA solution was mixed with Comassie Blue dye. FIG. 3C is a photograph of a portion of the addressable two-dimensional microfluidic device of FIG. 3A to which the BSA solution containing the blue dye was controllably delivered. As shown, the microfluidic device was electrically controlled to deliver the BSA solution to microchambers so as to form the letter “A”.

It should be noted that controlling the movement of the BSA solution in the microfluidic device proved to be more difficult than controlling the pure PBS solution. This was because proteins in the BSA solution came to rest on the walls of the microchannels, and thereby changed the surface energy of the microchannels. This, in turn, affected the electrocapillary pressure that could be formed in the microchannels. The effect of protein adsorption to the walls of the microchannels could be reduced by coating the microchannels surfaces with a layer of organic films, or by flushing the microchannels with KNO₃ solution immediately after the use of solutions containing proteins.

Next, an experiment was conducted to evaluate the possibility of patterning and growing cells in the addressable microchambers of the microfluidic device. LB Broth, which is normally used for maintaining and cultivating recombinant strains of Escherichia coli, was used to construct a letter “S” in the microfluidic device. As shown in FIG. 3D, four different compositions of LB Broth were used in this experiment, each of which was mixed with a different dye. Specifically, the horizontal top line of the letter “S” (marked as reference numeral 310) was formed using one composition. Similarly, the horizontal middle line of the letter “S” (marked with reference numeral 320), the horizontal bottom line (marked with reference numeral 330), and the two vertical portions (marked with reference numerals 340a and 340b) were each formed from different compositions of LB Broth. Thus, as shown in FIG. 3D, the addressable microfluidic device may be controlled to deliver different solutions to the various microchambers on the microfluidic device.

### Applications

One application that may be implemented using the electrically controlled addressable microfluidic device described herein is that of a photonic display.

In particular, microfluidic networks fabricated using PDMS can be sealed reversibly by conformal contact, thereby enabling the growing and formation of materials inside the microchambers of microfluidic devices. Accordingly, the microfluidic device described herein may be used to form colloidal crystal, thus enabling the microfluidic device to serve as a photonic display.

For example, in one experiment monodispersed polystyrene particles were first mixed with a KNO₃ solution (10⁻⁴ M, 1:1). The resultant colloidal solution was then transported to a set of desired microchambers using the electrical control mechanism and procedure describe herein (i.e., through selective activation of the electrodes in the electrical connection network of the microfluidic device). After the solvent in the solution evaporated, the colloidal particles self-assembled (through an evaporation induce self-assembly process) into well-ordered three-dimensional periodic nanostructures forming colloidal crystals in the selected microchambers.

The particular nature of the colloidal crystal formed in each microchamber controls the optical wavelength that that colloidal crystal can diffract. For example, polystyrene nanoparticles having respective diameters (and thus respective periodicity) of 210 nm and 250 nm diffract different colors of light (polystyrene nanoparticles with a 210 nm diameter diffract a red color, whereas a polystyrene nanoparticles having a 250 nm diameter diffract a blue color).

Accordingly, to display images, different polystyrene nanoparticles having corresponding diameters can be delivered to selected microchambers. Once delivered, those polystyrene nanoparticles form into colloidal crystals having the corresponding diameters. Light illuminated on, or through the microfluidic device will cause the colloidal crystals contained in the various microchambers to diffract different colors of light according to the pre-designed pattern used to deliver the polystyrene nanoparticles to their respective microchambers. As a result, a desired image will be displayed. To display a different image, the formed crystals in the microchambers are flushed out (using, for example, high pressure gas, or 10⁻⁴ M KNO₃ flushing solution), and a new set of polystyrene nanoparticles is delivered to the microfluidic device. The microfluidic device is then illuminated to display the new image.

Additionally, the addressable multi-dimensional microfluidic device described herein makes it suitable to function as a DNA or protein array. Particularly, different DNA samples may be efficiently delivered to various microchambers in the microfluidic device without having to manually place those samples into the individual microchambers. Rather, a DNA sample may be delivered to the fluid reservoir (such as fluid reservoir 120), whereupon the electrical connections network 200 can be used to electrically control the delivery of that sample to the desired microchambers. Similarly, the microfluidic device described herein may also function as a protein array, thereby enabling easy distribution of protein samples (and/or other biological samples) to desired microchambers on the microfluidic device described herein.

### OTHER EMBODIMENTS

A number of embodiments of the invention have been described. Nevertheless, it will be understood that various modifications may be made without departing from the spirit and scope of the invention. Accordingly, other embodiments are within the scope of the following claims.

What is claimed is:

1. A microfluidic device comprising:
one or more microchannels configured to transport fluid;
one or more microchambers configured to receive the fluid, wherein each of the one or more microchannels is coupled in fluid communication to at least one of the one or more microchambers;
a first set of electrodes, each of the electrodes electrically coupled to one of the one or more microchannels, and configured to selectively apply an adjustable voltage to the respective microchannel to cause the fluid in that microchannel to flow; and
a second set of electrodes, where each of the electrodes in the second set of electrodes is electrically coupled to corresponding microchambers and configured to apply an adjustable voltage to the corresponding microchambers to direct flowing fluid into those corresponding microchambers from the microchannels to which those corresponding microchambers are coupled.

2. The microfluidic device of claim 1, wherein the one or more microchannels and the one or more microchambers are arranged in a two-dimensional configuration.

3. The microfluidic device of claim 1, wherein the one or more microchannels and the one or more microchambers are disposed on a first substrate.

4. The microfluidic device of claim 3, wherein the first substrate is manufactured from polydimethylsiloxane.

5. The microfluidic device of claim 1, wherein the first set of electrodes and the second set of electrode are disposes on a second substrate.

6. The microfluidic device of claim 5, wherein the second substrate is manufactured from ITO glass.

7. The microfluidic device of claim 1, further comprising:
at least one fluid reservoir having an inlet opening, the at least one fluid reservoir configured to receive the fluid; and
a delivery channel having a hollow interior, the delivery channel coupled in fluid communication to an opening of the at least one fluid reservoir and to the openings of the one or more microchannels, the delivery channel configured to deliver the fluid from the at least one fluid reservoir to at least some of the one or more microchannels.

8. The microfluidic device of claim 7, further comprising a third set of electrodes electrically coupled to the at least one fluid reservoir and to the delivery channel, the third set of electrodes configured to apply an adjustable voltage to the at least one fluid reservoir and to the delivery channel to cause fluid to flow in the delivery channel.

9. The microfluidic device of claim 1, wherein each of the one or more microchambers includes an inlet to receive the fluid from the respective microchannel to which that microchamber is coupled.

10. The microfluidic device of claim 1, wherein each of the one or more microchambers is coupled in fluid communication to a corresponding drainage channel configured to deliver processed materials from that microchamber to one or more drainage fluid reservoirs.

11. The microfluidic device of claim 10, wherein each of the one or more microchambers includes an outlet coupled in fluid communication to the corresponding drainage channel.

12. The microfluidic device of claim 1, wherein the one or more microchannels is coated with organic film.

13. The microfluidic device of claim 1, wherein the fluid includes at least one of: biological samples, and chemical samples.

14. The microfluidic device of claim 1, further comprising a flushing mechanism configured to flush out the fluid from at least one of: the one or more microchannels, and the one or more microchambers.

15. The microfluidic device of claim 14, wherein the flushing mechanism includes a pump configured to pump into the microfluidic device at least one of: a flushing solution, and a high pressure gas.

16. A method for delivering fluid to a microchamber in a microfluidic device, the method comprising:
providing fluid to the opening of a microchannel coupled in fluid communication to the microchamber;
applying a first electrical voltage to the microchannel to cause the fluid to flow in the microchannel; and
applying a second electric voltage to the microchamber to direct the flowing fluid in the microchannel into the microchamber.

17. The method of claim 16, further comprising draining the fluid in the microchannel.

18. The method of claim 17, wherein draining the fluid comprises suspending the first electrical voltage applied to microchannel to cause the fluid to withdraw from the microchannel.

19. The method of claim 16, further comprising pumping flushing materials into the microfluidic device to remove materials located in the microfluidic device.

20. A method for delivering fluid to a particular microchamber disposed in a multi-dimensional microfluidic device, the device comprising one or more microchambers, where each of the one or more microchambers is coupled in fluid communication to one of one or more microchannels, the method comprising:
providing fluid to a reservoir coupled in fluid communication to the one or more microchannels;
applying a first voltage to a microchannel coupled to the particular microchamber, the microchannel selected from the one or more microchannels; and
applying a second voltage to the fluid flowing in the selected microchannel to direct the flowing fluid into the particular microchamber.

21. The method of claim 20, wherein applying the second voltage includes applying the second voltage at a position proximate to the particular microchamber.

22. The method of claim 20, further comprising draining the fluid in the selected microchannel.

23. The method of claim 22, wherein draining the fluid comprises suspending the first voltage applied to the selected microchannel.

24. The method of claim 20, further comprising flushing the fluid from the particular microchamber.

25. The method of claim 24, wherein flushing the fluid comprises:
pumping flushing materials into the microfluidic device to remove materials located in the particular microchamber.

26. A photonic display device comprising:
a fluid reservoir configured to receive at least one type of polystyrene nanoparticles characterized by an associated colloidal diameter;
one or more microchannels configured to transport the at least one type of polystyrene nanoparticles;
one or more microchambers configured to receive the at least one type of polystyrene nanoparticles and to form a colloidal crystal therefrom, wherein each of the one or more microchannels is coupled in fluid communication to at least one of the one or more microchambers;
a first set of electrodes, each of the electrodes electrically coupled to one of the one or more microchannels, and configured to selectively apply an adjustable voltage to the respective microchannel to cause the at least one type of polystyrene nanoparticles in that microchannel to flow;
a second set of electrodes, where each of the electrodes in the second set of electrodes is electrically coupled to corresponding microchambers and configured to selectively apply an adjustable voltage to the corresponding microchambers to direct into those corresponding microchambers the at least one type of polystyrene nanoparticles flowing in the microchannels to which those corresponding microchambers are coupled; and
a light source configured to illuminate the one or more microchambers.

27. The photonic display device of claim 26, further comprising a flushing mechanism configured to remove the at least one type of polystyrene nanoparticles from the at least one of: the one or more microchannels, and the one or more microchambers.

28. A method for displaying images on a multi-dimensional microfluidic device, the device comprising one or more microchambers, where each of the one or more microchambers is coupled in fluid communication to one of one or more microchannels, the method comprising:
providing at least one type of polystyrene nanoparticles to a reservoir coupled in fluid communication to the one or more microchannels;
applying a first voltage to a microchannel coupled to a particular microchamber, the microchannel selected from the one or more microchannels, to cause the at least one type of polystyrene nanoparticles to flow into the selected microchannel;
applying a second voltage to selectively direct into the particular microchamber the at least one type of polystyrene nanoparticles flowing in the selected microchannel; and
illuminating light on the one or more microchambers.

29. The method of claim 28, further comprising flushing the at least one type of polystyrene nanoparticles from the at least one of: the one or more microchannels, and the one or more microchambers.
